(19) United States
(12) Patent Application Publication
(10) Pub. No.: US 2003/0214265 A1
(43) Pub. Date: Nov. 20, 2003

(54) Stepper driver system with current feedback

(76) Inventors: Joel C. VanderZee, La Crosse, WI (US); Thomas G. Krajewski, La Crosse, WI (US)

Correspondence Address: William O'Driscoll - 12-1, Trane, 3600 Pammel Creek Road, La Crosse, WI, 54601, US

(21) Appl. No.: 10/153,193

(22) Filed: May 20, 2002

(51) Int. Cl. G05B 19/40

(52) U.S. Cl. 318/685

(57) ABSTRACT

A system for driving a stepper motor and adapting characteristic parameters of the stepper motor comprising a driver sub-system, responsive to control signals, for transferring power to the stepper motor. A power supply provides a driver current to the driver sub-system. A current detection device, responsive to the driver current, generates a digital feedback signal representative of the driver current. A digital processor, responsive to the digital feedback signal, generates the control signals. The digital processor is further responsive to a software algorithm to generate the control signals. These control signals provide functionality comprising detecting forces applied by the stepper motor to a load preventing a stall condition, adapting stepper motor speed and torque parameters, and limiting applied forces and driver current.

### BACKGROUND OF THE INVENTION

This disclosed embodiment relates to a system that drives and controls a stepper motor such as the type used in a commercial chiller system. More particularly, this disclosed embodiment relates to adapting and limiting characteristic parameters of the stepper motor such as speed, acceleration rate, torque, and applied force using current feedback in, for example, a commercial chiller system.

Over a normal range of operating speed, a stepper motor such as is used, for example, to move the guide vanes on a centrifugal compressor is capable of producing different maximum torque. At higher speed, the torque capability is less. The force requirement imposed on the stepper motor by the guide vanes is variable and depends on factors including the position of the vanes, operating conditions of the chiller, and aging (increase of force over time due to wear) of the stepper motor and drive components. It is desired to move the vanes as quickly as possible subject to the limitation of the force requirements.

Sufficient force is required to accelerate or decelerate the stepper motor and attached linkage and guide vanes. Other phenomena that can be detected by changes in force parameters include stall of the motor (when force capability is exceeded, such as at the end of travel) and compressor surge.

Previously, a separate controller matched to the particular application prescribed the speed of the stepper motor. Different chillers have different force requirements as a function of vane position, therefore, the most restrictive requirement has been used in order to ensure that all systems are adequately controlled. New applications could require new software or a new configuration. It would be necessary to determine force requirements of each new application analytically or experimentally.

U.S. Pat. No. 3,355,906 to Newton shows pre-rotational vanes 22 whose positions are changed by a temperature responsive controller 24. U.S. Pat. No. 4,084,120 to Lund recognizes that position feedbacks are used to monitor valve position, and that a zero voltage crossing switch or timing signal generating means 25 apparently delays its output signal to synchronize it with the inherent lag from the inductive loading of the coils. U.S. Pat. No. 4,604,036 to Sutou et al. includes a torque control apparatus where a load torque is detected by a position detector and a temperature detector in the refrigeration cycle. U.S. Pat. No. 4,686,834 to Haley et al. shows a vane positioning means 26 for opening or closing inlet guide vanes 20. U.S. Pat. No. 4,694,390 to Lee includes a motor operated valve 22 including a bidirectional motor 24 driving a worm shaft 52. U.S. Pat. No. 5,417,083 to Eber shows an electronic expansion valve driven by a stepper motor U.S. Pat. No. 5,417,083 to Eber and U.S. Pat. No. 4,686,834 to Haley et al. are commonly assigned with the present invention and are hereby incorporated by reference as background material relating to inlet guide vanes and stepper motors.

An approach to indirectly detect and adaptively limit and control characteristic parameters of a stepper motor to maximize system efficiency and prevent stalling of the stepper motor is desired.

### BRIEF SUMMARY OF THE INVENTION

One aspect of the disclosed embodiment is a system capable of controlling a stepper motor that drives a load such as the guide vanes of a commercial chiller system. A stepper motor typically converts a series of power pulses to a corresponding series of equal angular movements. These pulses can be delivered to the stepper motor by a system at a variable rate. This allows the accurate positioning of the rotor of the stepper motor. When the stepper motor is connected to a load such as guide vanes through a linkage mechanism, torque can be produced to apply force to the load to do work. In the case of guide vanes the work done is, for example, moving the guide vanes to a new position.

Apparatus is provided for adaptively limiting and controlling a stepper motor with a system by providing feedback of driver current that varies with the demands of the stepper motor. “Limiting and controlling” means driving the stepper motor in a desired manner to create the torques on the stepper motor and forces on the load to achieve a desired effect on the load such that pre-determined characteristic parameter limits are not exceeded. This apparatus includes a current detection device that monitors driver current to a driver sub-system and provides a digital feedback signal, representative of the driver current, to a digital processor for the purpose of indirectly detecting characteristic parameters. The digital processor generates control signals to the driver sub-system in response to the digital feedback signal and a software algorithm, thus achieving the adaptive feature.

Another aspect of the disclosed embodiment is a serial digital interface between the system and other devices of the commercial chiller system. The digital processor in the system is able to communicate and cooperate with these other devices through this interface to control the chiller.

A method is provided for adaptively limiting and controlling a stepper motor by providing feedback of driver current that varies with the demands of the stepper motor. “Limiting and controlling” means driving the stepper motor in a desired manner to create the torques on the stepper motor and forces on the load to achieve a desired effect on the load such that pre-determined characteristic parameter limits are not exceeded. This method includes monitoring driver current and providing a digital feedback signal representative of the driver current to indirectly detect characteristic parameters. Control signals are generated in response to the digital feedback signal and a software algorithm, thus achieving the adaptive feature.

Another aspect of the disclosed embodiment is a method for communicating between the system and other devices of the commercial chiller system. The system is able to communicate and cooperate with these other devices to control the chiller.

Yet another aspect of the present invention is a method of controlling a stepper motor to position a load through a mechanical linkage comprising the steps of: measuring the electrical current driving the stepper motor; determining a measure of a force on the mechanical linkage as a function of the measured current; and controlling the speed of the motor as a function of the determined force.

Still another aspect of the present invention is a method of controlling a stepper motor to position a load through a mechanical linkage comprising the steps of: measuring the electrical current driving the stepper motor; determining an acceleration of the stepper motor as a function of the measured current; and controlling the speed of the motor as a function of the determined acceleration.

A further aspect of the present invention is a method of controlling a stepper motor to position a load through a mechanical linkage. The method comprises the steps of: measuring the electrical current driving the stepper motor; determining a measure of a force on the mechanical linkage as a function of the measured current; determining an acceleration of the stepper motor as a function of the measured current; and controlling the speed of the motor as a function of the determined force or acceleration.

An additional aspect of the present invention is an apparatus of controlling a stepper motor to position a load through a mechanical linkage. The apparatus comprises hardware or software measuring the electrical current driving the stepper motor; hardware and software determining a measure of a force on the mechanical linkage as a function of the measured current; and hardware and software controlling the speed of the motor as a function of the determined force.

Another aspect of the present invention is an apparatus controlling a stepper motor to position a load through a mechanical linkage. The apparatus comprises: hardware or software measuring the electrical current driving the stepper motor; hardware or software determining an acceleration of the stepper motor as a function of the measured current; and hardware or software controlling the speed of the motor as a function of the determined acceleration.

A still further aspect of the present invention is apparatus controlling a stepper motor to position a load through a mechanical linkage. The apparatus comprises: a sensor operably connected to the stepper motor and measuring the electrical current driving the stepper motor; a controller operably connected to the sensor and determining at least one of a measure of a force on the mechanical linkage as a function of the measured current, or an acceleration of the stepper motor as a function of the measured current; and the controller controlling the speed of the motor as a function of the determined force or acceleration.

By using the foregoing techniques, indirect detection and adaptive limiting and controlling of characteristic parameters of a stepper motor to maximize system efficiency and prevent stalling of the stepper motor is achieved.

### BRIEF DESCRIPTION OF THE DRAWINGS

FIG. 1 is a schematic block diagram of a system that drives and controls a stepper motor using a digital feedback signal.

### DETAILED DESCRIPTION OF THE INVENTION

The features of one embodiment enable an apparatus and method for adaptively driving and controlling a stepper motor in a commercial chiller system using current draw as a digital feedback signal. Indirect detection of characteristic parameters and conditions such as force parameters, acceleration rates, and stall conditions is thereby achieved. The system reacts to these characteristic parameters and conditions to adaptively limit and control the stepper motor. This is accomplished by monitoring a current of the system that varies with the demands of the stepper motor and generating control signals based on the monitored current and software algorithms.

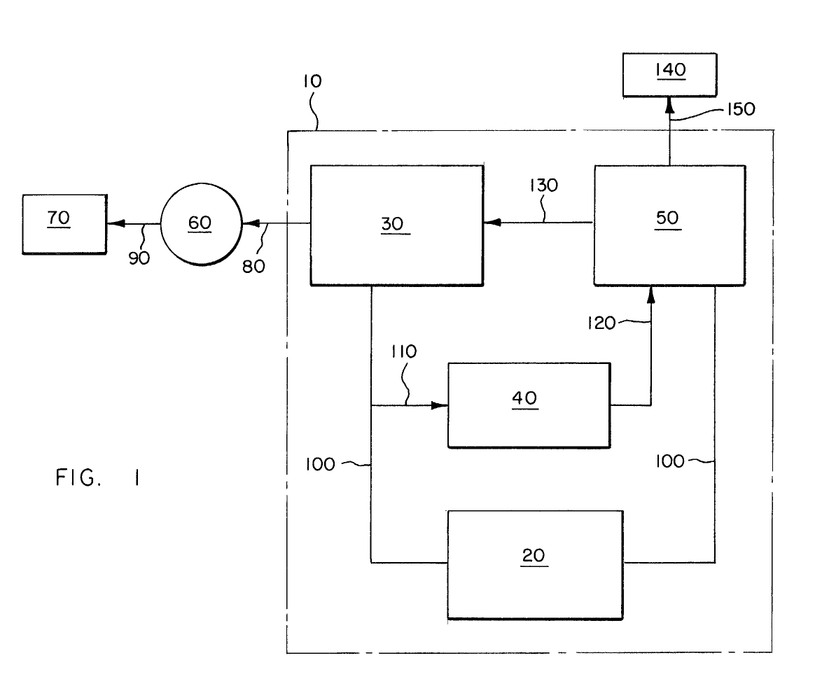

FIG. 1 is a schematic block diagram of a system 10 made in accordance with the disclosed embodiment. The system 10 comprises a power supply 20, a driver sub-system 30, a current detection device 40, and a digital processor 50. This system 10 electronically drives a stepper motor 60 that mechanically drives a load 70.

Referring to FIG. 1, the driver sub-system 30 of the system 10 is electrically connected to the stepper motor 60 through a driving signal interface 80. The stepper motor 60 is mechanically connected to the load 70 through a linkage interface 90. The power supply 20 receives power from a voltage regulated power source 22 via bus 24. The power supply 20 is electrically connected to the driver sub-system 30 and the digital processor 50 through a power interface 100. The current detection device 40 is electrically connected to the power interface 100 at a feedback input 110. The digital processor 50 is electrically connected to the current detection device 40 through a feedback interface 120. The digital processor 50 is electrically connected to the driver sub-system 30 through a control signal interface 130. The digital processor 50 is electrically connected to other devices 140 through digital serial interface 150. In the preferred embodiment, devices 140 may comprise a CH.530™ controller sold by The Trane Company of La Crosse, Wis. for controlling a CenTraVac® centrifugal chiller.

During operation, the current detection device 40 measures the driver current supplied to the driver sub-system 30 by sampling the driver current through the feedback input 110. This measured driver current is provided to the digital processor 50 over the feedback interface 120 in the form of a digital feedback signal generated by the current detection device 40. In the disclosed embodiment, the current detection device 40 is a simple current sensing device comprising a resistor and a differential amplifier, and outputs an analog signal to the digital processor 50 (and to an analog-to-digital converter in the processor 50) that is representative of the measured driver current. The measured driver current is an indirect indicator of a force applied to the linkage interface 90 and is also an indirect indicator of the work required to accelerate a rotor inside the stepper motor 60 that is connected to the linkage interface 90. The speed of the motor is determined by the step rate driven by the controller. The current increases as necessary due to the load. The increasing speed may show more current in an amount depending on the inertia of the motor and the load. When the driver current is increasing, more work is being done due to the force and torque created by the motor 60.

The digital processor 50 reads the digital feedback signal and applies a software algorithm to generate control signals. These controls signals are sent to the driver sub-system 30 over the control signal interface 130. The driver sub-system 30 converts these control signals to driving signals that drive the stepper motor 60 over the driving signal interface 80. As the stepper motor 60 is driven, the driver current will tend to change based on the changing forces and accelerations associated with the stepper motor 60, the linkage interface 90, and the load 70. These changes in driver current are detected by the current detection device 40 and provided to the digital processor 50 over the feedback interface 120 as a new digital feedback signal. The digital processor 50 then generates new control signals based on this new digital feedback signal. Hence, the method of driving and controlling the stepper motor is adaptive. The software algorithm, applied by the digital processor 50, uses the digital feedback signal information to detect and adaptively control and limit various characteristic parameters of the stepper motor 60 and the associated linkage interface 90 and the load 70. The characteristic parameter that is directly controlled and adapted is the speed of the motor. This speed determines the torque. The speed of the motor 60 is controlled such that it changes gradually, up and down, depending on whether the driver current is above or below a predetermined target driver current. The amount of driver current that is drawn from the power supply 20 by the driver sub-system 30 is predictable based on how the motor 60 is to be driven. Therefore, target driver currents can be pre-determined.

In the disclosed embodiment, the software algorithm is responsive to the digital feedback signal to accomplish several functions. First, the algorithm detects certain conditions of the stepper motor 60. Specifically, the algorithm indirectly detects force and changes in force (acceleration rate) applied by the stepper motor 60 to the linkage interface 90 and the load 70 based on the digital feedback signal.

Second, the algorithm generates control signals to control certain characteristic parameters of the stepper motor 60, the associated linkage interface 90 and the load 70. Specifically, the algorithm generates control signals that adapt the speed and torque of the stepper motor 60 as needed for the application, for example, to prevent a stall condition. It is generally desired to prevent a stall condition and allow the motor 60 to move as fast as possible. However, the speed of the motor 60 must be slow enough so driver current levels are high enough to provide the required torque. The digital feedback signal allows this balance between required torque and high speed to be achieved.

Third, the algorithm limits certain characteristic parameters. Specifically, the algorithm generates control signals that limit the acceleration rate of the stepper motor 60 and limit the driver current supplied to the stepper motor 60 to pre-defined limits. The driver current is limited since the power supply can only provide a certain maximum driver current. Also, the driver current may be limited to prevent excessive build up of heat in the system 10. Under some conditions, the algorithm also limits the amount of force that gets applied to the load 70 through the linkage interface 90.

Finally, the system is able to communicate with other devices 140 of the commercial chiller system through the external serial digital interface 150. Stepper motor position commands and status are communicated. For example, a detected stall condition of the stepper motor 60 can be reported. Preferably, the interface 150 and the bus 24 are a single connection but a person of skill in the art will recognize that they may be implemented as separate connections.

What has been described is a method of controlling a stepper motor where voltage is regulated and current is presumed to be directly proportional to power thereby allowing a force to be assumed as proportional to power. The force may either be the load on the stepper motor or the actuator, or the acceleration of the stepper motor or the actuator.

While the invention is described in connection with one embodiment, it will be understood that the invention is not limited to that one embodiment. On the contrary, the invention covers all alternatives, modifications, and equivalents within the spirit and scope of the appended claims.

For example, some possible alternatives might include the following described below. The digital processor could be separate from the system and communicate over an external interface to accomplish the same functions.

As another alternative, other information that is different from that information described above may be communicated between the system and other devices of the commercial chiller system.

As a further alternative, a strain gauge or other sensor could be used to measure the force on the linkage interface of the stepper motor. Electronics to read the sensor could be included in the system or could be external and communicate through an external interface between the two. Force measurements could be communicated from the system or a separate device. Control processing could occur within the system or could be done by a separate device that takes the measurements, or by other separate devices such as a master digital processor in a control network.

As a further alternative, the software algorithm could actually be multiple algorithms used at various times by the digital processor.

And still, a further alternative is that the various system components could be combined in various ways. For example, the digital processor 50 could be part of the driver sub-system 30 as could be the current detection device 40, or the analog-to-digital converter in the processor 50 could be located outside of the processor 50. Additionally, the power supply 20 may be located outside of the system 10. Also, other conventional current detection devices can be substituted for the current detection device 40 described herein. Furthermore, the preferred embodiment uses a voltage regulated bus and can assume that power is proportional to current since voltage is constant. If the voltage was not regulated (i.e. constant or known), the voltage would be measured and power then calculated from the proposed currents and voltages.

Furthermore, the application of the stepper motor may be varied from the commercial chiller system described as the preferred embodiment to other applications in which stepper motors are used.

What is claimed is:

1. In a system for driving a stepper motor, apparatus for detecting and adaptively limiting and adjusting characteristic parameters and conditions of said stepper motor comprising:
a driver sub-system, responsive to control signals, for transferring power to said stepper motor;
a power supply to provide a driver power to said driver sub-system that varies with the demands of said stepper motor;
a power detection device, responsive to said driver power, to generate a digital feedback signal representative of said driver power; and
a digital processor, responsive to said digital feedback signal, to generate said control signals.

2. The apparatus of claim 1 wherein said digital processor is further responsive to a software algorithm to generate said control signals.

3. The apparatus of claim 1 wherein said digital processor is responsive to said digital feedback signal and a software algorithm for indirectly detecting a force parameter and changes of said force parameter applied by said stepper motor.

4. The apparatus of claim 1 further comprising a digital interface to allow said system to communicate with devices external to said system.

5. The apparatus of claim 1 wherein the power supply includes a regulated voltage and the driver power includes a driver current and the power detection device determines power as a function of the driver current.

6. The apparatus of claim 5 wherein said driver sub-system is responsive to said control signals to gradually adapt a speed parameter of said stepper motor up and down as a result of said driver current moving above and below a pre-determined target driver current.

7. The apparatus of claim 5 wherein said driver sub-system is responsive to said control signals to drive said stepper motor at a speed that is as fast as possible while simultaneously allowing a sufficient driver current to be provided such that a resultant torque parameter is sufficient to prevent a stall condition of said stepper motor.

8. The apparatus of claim 5 wherein said driver sub-system is responsive to said control signals to limit an acceleration rate parameter of said stepper motor.

9. The apparatus of claim 5 wherein said driver current is limited in response to said control signals.

10. The apparatus of claim 2 wherein said driver sub-system is responsive to said control signals to gradually adapt a speed parameter of said stepper motor up and down as a result of said driver power moving above and below a pre-determined target driver power.

11. The apparatus of claim 2 wherein said driver sub-system is responsive to said control signals to drive said stepper motor at a speed that is as fast as possible while simultaneously allowing a sufficient driver power to be provided such that a resultant torque parameter is sufficient to prevent a stall condition of said stepper motor.

12. The apparatus of claim 2 wherein said driver sub-system is responsive to said control signals to limit an acceleration rate parameter of said stepper motor.

13. The apparatus of claim 2 wherein said driver power is limited in response to said control signals.

14. The apparatus of claim 2 wherein said driver sub-system is responsive to said control signals to limit a force parameter applied to a load by said stepper motor.

15. In a system for driving a stepper motor, method for detecting and adaptively limiting and adjusting characteristic parameters and conditions of said stepper motor comprising:
responding to control signals to transfer power to said stepper motor;
supplying power to provide a driver power that varies with the demands of said stepper motor;
generating a digital feedback signal representative of said driver power; and
generating said control signals in response to said digital feedback signal.

16. The method of claim 15 wherein said generating said control signals further comprises a software algorithm being responsive to said digital feedback signal.

17. The method of claim 15 wherein the driver power includes a driver current and a driver current is directly proportional to the driver power.

18. The method of claim 17 further comprising adapting a speed parameter of said stepper motor up and down in response to said control signals as a result of said driver current moving above and below a pre-determined target driver current.

19. The method of claim 17 further comprising adapting a speed parameter of said stepper motor to drive said stepper motor at a speed that is as fast as possible while simultaneously allowing a sufficient driver current to be provided such that a resultant torque parameter is sufficient to prevent a stall condition of said stepper motor.

20. The method of claim 17 further comprising limiting said driver power in response to said control signals.

21. The method of claim 15 further comprising indirectly detecting a force parameter and changes of said force parameter applied by said stepper motor in response to said digital feedback signal and a software algorithm.

22. The method of claim 15 further comprising communicating between said system and devices external to said system.

23. The method of claim 16 further comprising adapting a speed parameter of said stepper motor up and down in response to said control signals as a result of said driver power moving above and below a pre-determined target driver power.

24. The method of claim 16 further comprising adapting a speed parameter of said stepper motor to drive said stepper motor at a speed that is as fast as possible while simultaneously allowing a sufficient driver power to be provided such that a resultant torque parameter is sufficient to prevent a stall condition of said stepper motor.

25. The method of claim 16 further comprising limiting an acceleration rate parameter of said stepper motor in response to said control signals.

26. The method of claim 16 further comprising limiting said driver power in response to said control signals.

27. The method of claim 16 further comprising limiting a force parameter applied by said stepper motor in response to said control signals.

28. A method of controlling a stepper motor to position a load through a mechanical linkage comprising the steps of:
measuring the electrical power driving the stepper motor;
determining a measure of a force on the mechanical linkage as a function of the measured power; and
controlling the speed of the motor as a function of the determined force.

29. The method of claim 28 including a further step of maintaining a minimum torque as a function of the measured force.

30. The method of claim 29 including the further step of determining an acceleration of the stepper motor as a function of the measured power.

31. The method of claim 30 including the further step of limiting the determined acceleration through a predetermined maximum acceleration.

32. The method of claim 31 wherein the power measuring step measures current but not voltage.

33. The method of claim 28 wherein the power measuring step measures current but not voltage.

34. A method of controlling a stepper motor to position a load through a mechanical linkage comprising the steps of:
measuring the electrical power driving the stepper motor;
determining a force on the stepper motor as a function of the measured power; and
controlling the speed of the motor as a function of the determined force.

35. The method of claim 34 wherein the speed of the motor is controlled by varying a step rate, and including the further step of limiting the determined force to a predetermined maximum step rate.

36. The method of claim 35 including the further step of determining a measure of a force on the mechanical linkage as a function of the measured power.

37. The method of claim 36 including the further step of maintaining a minimum torque as a function of the measured force.

38. The method of claim 36 including the further step of measuring the electrical current, but not the voltage, driving the stepper motor and wherein the power measuring step determines the measured power as a function of the measured current.

39. A method of controlling a stepper motor to position a load through a mechanical linkage comprising the steps of:
determining the power driving the stepper motor;
determining a measure of a force on the mechanical linkage as a function of the determined power; and
controlling the speed of the motor as a function of the determined force.

40. The method of claim 39 including the further step of determining an acceleration of the stepper motor as a function of the measured power and controlling the speed as a function of either the force or the acceleration.

41. The method of claim 39 including the further step of measuring an electrical current driving the stepper motor and wherein the power determining step determines power as a function of the measured current.

42. An apparatus of controlling a stepper motor to position a load through a mechanical linkage comprising:
means for measuring the power driving the stepper motor;
means for determining a measure of a force on the mechanical linkage as a function of the measured power; and
means for controlling the speed of the motor as a function of the determined force.

43. The apparatus of claim 42 further including means for maintaining a minimum torque as a function of the measured force.

44. The apparatus of claim 43 further including means for measuring an electrical current driving the stepper motor, and wherein the power measuring means includes the current measuring means and determines power in proportion to current.

45. The apparatus of claim 43 further including means for determining an acceleration of the stepper motor as a function of the measured current.

46. The apparatus of claim 45 further including means for limiting the determined acceleration to a predetermined maximum acceleration.

47. An apparatus controlling a stepper motor to position a load through a mechanical linkage comprising:
means for measuring the electrical current driving the stepper motor;
means for determining a force on the stepper motor as a function of the measured current; and
means for controlling the speed of the motor as a function of the determined force.

48. The apparatus of claim 47 further including means for limiting the determined force to a predetermined maximum force.

49. The method of claim 47 further including means for determining a measure of a force on the mechanical linkage as a function of the measured current;

50. The method of claim 49 further including means for maintaining a minimum torque as a function of the measured force.

51. Apparatus controlling a stepper motor to position a load through a mechanical linkage comprising:
a sensor operably connected to the stepper motor and measuring the electrical current driving the stepper motor;
a controller operably connected to the sensor and determining at least one of a measure of a first force on the mechanical linkage as a function of the measured current, or a second force on the stepper motor as a function of the measured current; and
the controller controlling the speed of the motor as a function of the determined first or second forces.
